(19) United States
(12) Patent Application Publication
(10) Pub. No.: US 2014/0307455 A1
(43) Pub. Date: Oct. 16, 2014

(54) Temporary Vehicle Marker Light Assembly

(71) Applicant: Bret Owston, Mesquite, TX (US)

(72) Inventor: Bret Owston, Mesquite, TX (US)

(21) Appl. No.: 13/861,634

(22) Filed: Apr. 12, 2013

(51) Int. Cl. B60Q 1/00

(52) U.S. Cl. CPC B60Q 1/00
USPC 362/485

(57) ABSTRACT

A temporary clearance or other marker light for a truck or trailer is herein disclosed. It is a temporary functional replacement for a permanent light that fails while the vehicle is in transit. The light of the present invention is lightweight and easy to affix on top of the faulty light. The light housing accommodates an illuminating element, a battery, and wiring equipped with an on/off switch. The front wall of the housing is made from a transparent colored material that allows light to go through. The back wall of said light is equipped with an adhesive mounting element. One side wall accommodates an attachment knob shaped to fit into a knob receptacle in an extension pole designed to reach the highest point on the perimeter of a truck and affix the clearance light in any requisite position.

### BACKGROUND OF THE INVENTION

1. Field of the Invention

The present invention relates to a field of vehicle marker or clearance lights, and more specifically to temporary replacement lights that can be readily employed in cases of a permanent light failure.

2. Description of Related Art

Means for providing illumination of a moving vehicle has been described in the prior art on a number of occasions. More specifically, by way of example, U.S. Pat. No. 2,057,965 to Neeley for a vehicle lamp addresses the need for vehicles to have its outer limits illuminated. It discloses a bidirectional light that is affixed to the sides of a truck thus making vehicle perimeter apparent from a distance. By embedding the lamp socket in the side of the vehicle wall this invention also offers a solution to the light being knocked off the vehicle or light bulb filament braking because of excessive vibration which often occurs the lamp is mounted on a bracket.

U.S. Pat. No. 4,051,360 to Slater discloses a lamp and mounting structure for clearance, tail, and stop lights for trucks, trailers and other vehicles requiring such lights. The invention includes an illuminating element and lamp housing that is pierced to allow an insulated electrical conductor of the vehicle to enter the housing, connect to the lighting element and complete the electric circuit within the housing. U.S. Pat. Nos. 3,831,018 and 3,789,209, both to Weber, also disclose vehicle lamps that are permanently affixed to a vehicle and connected to the vehicle electric circuit.

Other inventions such as those disclosed in U.S. Pat. Nos. 5,388,035 to Bodem and 6,623,150 to Roller propose modifications of lighting elements and incorporated optical elements to control light emission angles and improve vehicle visibility.

These inventions, however, do not address the problem a light failure creates when the vehicle is in transit. Compliance with federal, state and local motor vehicle safety regulations necessitate operational clearance lights on vehicles such as trucks and trailers. Therefore, such light failure often results in the issuance of a traffic violation and/or demand for immediate replacement of the light. Execution of these requests is often onerous and dangerous to the driver as clearance lights are placed on the outer perimeter of a truck, usually high above the ground, in hard to reach places. It requires climbing up the vehicle, using a screwdriver or a coin to take the light apart and replace the light bulb or another lighting element. Nighttime or daylight low visibility conditions usually compound the light replacement problems. Therefore, a quick-fix solution system is needed to remedy problems such light failure creates. The present invention presents such a solution.

### SUMMARY OF THE INVENTION

In an exemplary embodiment of the present invention, there is disclosed a temporary replacement clearance, tail or side light for a truck, trailer or another type of vehicle. It is meant as a temporary functional replacement for the permanent light that fails while the vehicle is in transit or whenever it is too difficult to substitute the permanent lighting element with an equivalent while on the road. Practice of the present invention does not require removal of any element of the permanent faulty light. The clearance light of the present invention is lightweight and easy to affix on top of the faulty light utilizing a mounting element positioned on its back wall and an attachment knob that is made to fit into a receptacle on an extension pole designed to reach the highest light on a truck or tractor trailer.

The clearance light of the present invention has an illuminating element encased in housing that accommodates also a removable power source, such as a battery, and wiring equipped with an on/off switch and connecting the power source to the illuminating element. The switch is accessible on one of the outer surfaces of the housing. The front wall of the housing is made from a transparent colored material that forms a lens allowing the light to go through. One side wall accommodates an attachment knob that is shaped to fit into a knob holder or a receptacle in the extension pole serving. The outside surface of the back wall is equipped with an adhesive or other mounting element that allows the light to be affixed at the requisite spot. The light housing is made of plastic, polyurethane or an equivalent light-weight, weather-proof material.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a schematic front view thereof.

FIG. 2 is a schematic side view thereof.

### DESCRIPTION OF THE PREFERRED EMBODIMENT

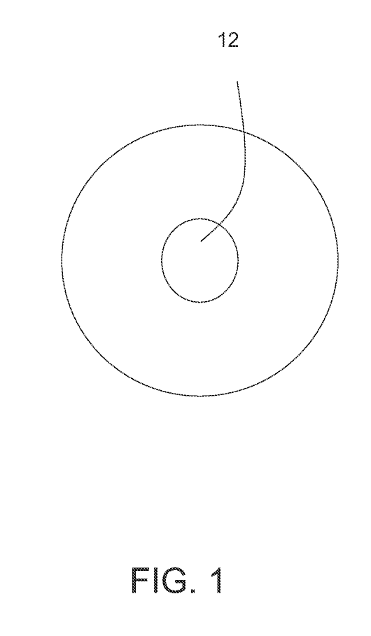

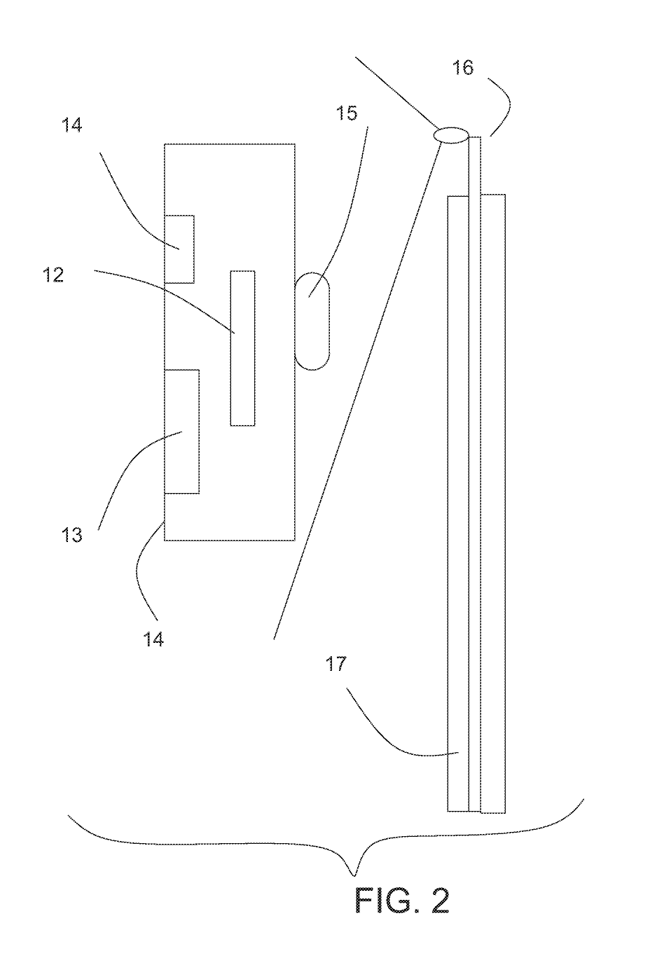

Referring to FIG. 1, there is disclosed a temporary replacement clearance light for a truck, trailer or another type of oversize vehicle. In one embodiment of the invention the light housing is substantially circular in shape with a diameter of 1½″. The front circular wall of the housing or a significant part of it made of a transparent colored material that creates a lens allowing light to pass through. FIG. 2 shows the housing 11 that accommodates a lighting member 12 that consists of one or more light emitting diodes (LED), connected to a battery 13 via electric circuit wiring equipped with an on/off switch 14. The exterior surface of a side wall has also an attachment knob 15 that is ½″ in diameter and projects ¼″ above the side wall surface. The knob is shaped to fit in a top receptacle opening 16 of an extension pole 17. The outer surface of the back circular wall is equipped with a double sided adhesive tape (not shown). The exposed surface of the tape can be sealed for storage with a protective film.

The light housing is made of plastic, polyurethane or an equivalent light-weight, weather-proof material utilizing molding techniques known in the art. While the preferred embodiment employs LED lighting element, the use of electric bulbs, fiber optics, or other lighting elements known in the art is also within the scope of the invention. The lens can be amber, red, white or another color should safety traffic regulations change. Also, a hook-and-loop tape or a different strong adhesive means that is capable of engaging the surface of a permanent light or truck exterior can be employed.

In practicing the invention, directly prior to the light placement the protective film of the adhesive element is peeled; the switch is turned to the “on” position; and the attachment knob is fitted into the receptacle opening on the extension pole. The pole is extended to a desired length to reach requisite placement spot and the light is affixed to the vehicle.

While there have been shown and described and pointed out the fundamental novel features of the invention, it will be understood that the foregoing is considered as illustrative only of the principles of the invention and not intended to be exhaustive or to limit the invention to the precise forms disclosed. Obvious modifications or variations are possible in light of the above teachings and are within the scope of the invention as determined by the appended claims when interpreted in accordance with the breadth to which they are entitled.

What is claimed is:

1. A temporary marker light assembly for a vehicle comprising:
A lighting member and a light housing,
said housing encasing said lighting member, a power source and wiring connecting said lighting member to said power source with a switch in between;
said light switch being accessible from the outside;
said housing having substantially transparent front wall, a back side wall opposite to said transparent housing wall with a mounting member on the outer surface of said back wall, and one side wall with an attachment knob,
said attachment knob made to fit a top receptacle of an extension pole,
said extension pole serving to affix said temporary light assembly in case of permanent marker light failure.

2. A temporary marker light assembly of claim 1 wherein said mounting member is an adhesive double sided tape.

3. A temporary marker light assembly of claim 1 wherein said mounting member is a hook-and-loop type of tape.

4. A temporary clearance light assembly comprising:
A lighting member and a light housing,
said housing encasing said lighting member, a power source and wiring connecting said lighting member to said power source with a switch in between;
said light switch being accessible from the outside;
said housing having substantially transparent front wall, a back side wall opposite to said transparent housing wall with an adhesive means on the outer surface of said back wall, and a side wall with an attachment knob,
said attachment knob made to fit a top receptacle of an extension pole,
said extension pole serving to affix said temporary light assembly in case of permanent clearance light failure.

5. A temporary marker light assembly of claim 4 wherein said mounting member is an adhesive double sided tape.

6. A temporary marker light assembly of claim 4 wherein said mounting member is a hook-and-loop type of tape.

7. A temporary vehicle side marker light assembly comprising:
A lighting member and a light housing,
said housing encasing said lighting member, a power source and wiring connecting said lighting member to said power source with a switch in between;
said light switch being accessible from the outside;
said housing having substantially transparent front wall, a back side wall opposite to said transparent housing wall with an adhesive means on the outer surface of said back wall, and a side wall with an attachment knob,
said attachment knob made to fit a top receptacle of an extension pole,
said extension pole serving to affix said temporary light assembly in case of permanent side marker light failure.

8. A temporary marker light assembly of claim 7 wherein said mounting member is an adhesive double sided tape.

9. A temporary marker light assembly of claim 7 wherein said mounting member is a hook-and-loop type of tape.
